(19) United States
(12) Patent Application Publication
(10) Pub. No.: US 2025/0005536 A1
(43) Pub. Date: Jan. 2, 2025

(54) PROVIDING ACCESS TO A TASK LOCATION

(71) Applicant: Textron Innovations Inc., Providence, RI (US)

(72) Inventor: Brian David Wanta, North Augusta, SC (US)

(21) Appl. No.: 18/216,672

(22) Filed: Jun. 30, 2023

(51) Int. Cl. G06Q 10/20; G06Q 10/0631; G06Q 10/0633

(52) U.S. Cl. CPC G06Q 10/20; G06Q 10/063116; G06Q 10/06316; G06Q 10/0633

(57) ABSTRACT

Techniques are directed to providing access to a location. Such techniques involve identifying a current device location for a device within a geographic region. Such techniques further involve, based on the current device location, projecting a time when the device will reach a task target location within the geographic region. Such techniques further involve, based on the projected time when the device will reach the task target location within the geographic region, electronically providing an availability time-window to perform a task at the task target location before the device reaches the task target location.

### BACKGROUND

A golf course includes holes on which groups of golfers play golf during the day. Such holes include tee boxes, fairways, greens, roughs, and so on.

To maintain good course conditions, the golf course typically employs a daytime maintenance crew. For example, the daytime maintenance crew may operate grass cutters to prevent the tee boxes, fairways, greens, roughs, etc. from getting too long. As another example, the daytime maintenance crew may operate a sprinkler system to prevent the tee boxes, fairways, greens, roughs, etc. from drying and wilting.

### SUMMARY

It is challenging to deploy daytime maintenance crews around golf courses efficiently to operate golf course equipment such as grass cutters and sprinklers while groups of golfers play golf during the day. Often the daytime maintenance crews are sent out to golf course holes in need of work (e.g., grass cutting, watering, etc.) and the crews sit and wait until openings between groups of golfers occur to enable the crews to perform their work. Frequently, crews start their work, move aside and wait to allow groups of golfers to play through, continue their work after the groups of golfers have played through, again move aside and wait to allow the next groups of golfers to play through, and so on until the work is finally finished. While the crews wait at the golf course holes, crew time is wasted. Additionally, the crews may let certain equipment idle wastefully such as gas powered grass cutters and/or other service vehicles/equipment thus further consuming energy and other resources unnecessarily. However, if the crews were to instead force groups of golfers to wait until the crews complete their work, such waiting by the groups of golfers would slow down the pace of play and worsen the golfing experience.

In contrast to the above-described approach to deploying daytime maintenance crews to golf course holes requiring work and making the crews wait for openings between groups of golfers to perform the work, improved techniques are directed to providing access to task locations based on current locations of devices and projections as to when the devices will leave and/or reach the task locations. Such techniques enable identification of availability time-windows at the task locations and smart assignment and/or scheduling of tasks to be performed at the task locations. Accordingly, tasks may be performed optimally rather than wastefully at the task locations and without causing interference, disruption, etc. (e.g., work crews do not need to wait and/or equipment does not need to sit idle wasting energy, etc.).

Along these lines, in the context of a golf course, different groups of golfers on the golf course may travel with devices signaling their current locations. Specialized circuitry may then identify paces of play (or rates of movement) for the golfer groups and where there are gaps between the golfer groups. Such information enables various tasks (e.g., mowing a fairway, irrigating all or portions of a hole, other well-defined groundskeeping tasks, combinations thereof, etc.) to be performed within the gaps as the golfer groups progress through the golf course. Moreover, such techniques preserve the golfer experience by enabling maintenance crews to avoid intruding and interfering with golf play.

One embodiment is directed to a method of providing access to a location. The method includes identifying a current device location for a device within a geographic region. The method further includes projecting, based on the current device location, a time when the device will reach a task target location within the geographic region. The method further includes electronically providing, based on the projected time when the device will reach the task target location within the geographic region, an availability time-window to perform a task at the task target location before the device reaches the task target location.

Another embodiment is directed to electronic circuitry to provide access to a location. The electronic circuitry includes a set of interfaces and a controller coupled with the set of interfaces. The controller is constructed and arranged to perform a method of:

(A) identifying a current device location for a device within a geographic region,
(B) based on the current device location, projecting a time when the device will reach a task target location within the geographic region, and
(C) based on the projected time when the device will reach the task target location within the geographic region, electronically providing an availability time-window to perform a task at the task target location before the device reaches the task target location through the set of interfaces.

Yet another embodiment is directed to a computer program product having a non-transitory computer readable medium which stores a set of instructions to provide access to a location. The set of instructions, when carried out by a processor, causing the the processor to perform a method of:
(A) identifying a current device location for a device within a geographic region;
(B) based on the current device location, projecting a time when the device will reach a task target location within the geographic region; and
(C) based on the projected time when the device will reach the task target location within the geographic region, electronically providing an availability time-window to perform a task at the task target location before the device reaches the task target location.

In some arrangements, the method further includes, after the availability time-window is provided, electronically identifying a set of tasks that are performable at the task target location before the device reaches the task target location.

In some arrangements, the geographic region is a golf course and the task target location is an area on a particular golf course hole of the golf course. Additionally, the device is constructed and arranged to travel with a task-ending set of golfers on the golf course. Furthermore, electronically identifying the set of tasks that are performable at the task target location includes providing a list of groundskeeping tasks that are performable at the area on the particular golf course hole before the task-ending set of golfers reaches the particular golf course hole.

In some arrangements, another device is constructed and arranged to travel with a task-starting set of golfers on the golf course, the task-starting set of golfers playing ahead of the task-ending set of golfers on the golf course. Additionally, the method further includes projecting a time when the other device will leave the task target location. The availability time-window is a time gap to perform the task at the task target location, the time gap being bounded by the time when the other device will leave the task target location and the time when the device will reach the task target location.

In some arrangements, providing the list of groundskeeping tasks includes:
(i) comparing, to the time gap, a predefined irrigation time to perform an irrigation task that irrigates the area on the particular golf course hole during the predefined irrigation time, and
(ii) performing a list update operation, the list update operation adding the irrigation task to the list of groundskeeping tasks when the predefined irrigation time fits within the time gap and omitting the irrigation task from the list of groundskeeping tasks when the predefined irrigation time does not fit within the time gap.

In some arrangements, providing the list of groundskeeping tasks includes:
(i) comparing, to the time gap, a predefined mowing time to perform a mowing task that mows the area on the particular golf course hole during the predefined mowing time, and
(ii) performing a list update operation, the list update operation adding the mowing task to the list of groundskeeping tasks when the predefined mowing time fits within the time gap and omitting the mowing task from the list of groundskeeping tasks when the predefined mowing time does not fit within the time gap.

In some arrangements, the golf course includes a sequence of golf course holes (e.g., Hole #1 through Hole #18). Additionally, identifying the current device location for the device within the geographic region includes identifying, among the sequence of golf course holes, a current golf course hole within which the device currently resides.

In some arrangements, the device includes global positioning system (GPS) circuitry and a wireless transmitter, the wireless transmitter being constructed and arrange to include a current GPS location identified by the GPS circuitry in the wireless signal. Additionally, identifying the current golf course hole includes extracting the current GPS location from the wireless signal, and mapping the current GPS location to the current golf course hole among the golf course holes of the sequence.

In some arrangements, identifying the current golf course hole includes receiving an indication that a Bluetooth detector has detected a Bluetooth beacon. Additionally, the Bluetooth detector is one of the device and a Bluetooth apparatus residing at the current golf course hole. Furthermore, the Bluetooth beacon is the other of the device and the Bluetooth apparatus residing at the current golf course hole.

In some arrangements, projecting the time when the device will reach the task target location within the geographic region includes:
(i) identifying a series of golf course holes between the current golf course hole and the particular golf course hole of the sequence,
(ii) identifying a set of hole playing times for the series of golf course holes between the current golf course hole and the particular golf course hole, and
(iii) providing the time when the device will reach the task target location based on an aggregate playing time derived from the set of hole playing times.

In some arrangements, the availability time-window has a start time and an end time. Additionally, electronically providing the availability time-window for performing the task includes setting the end time of the availability time-window to be no later than the task-ending timestamp.

In some arrangements, electronically identifying the set of tasks includes, from a plurality of candidate tasks having predefined task completion times, identifying (i) a set of candidate tasks having predefined task completion times which are shorter than the availability time-window and (ii) a set of candidate tasks having predefined task completion times which are longer the availability time-window. Additionally, electronically identifying the set of tasks includes placing only the set of candidate tasks having predefined task completion times which are shorter than the availability time-window on the list of groundskeeping tasks, the set of candidate tasks having predefined task completion times that are longer than the availability time-window being omitted from the list of groundskeeping tasks.

In some arrangements, projecting the time when the device will reach the task target location within the geographic region includes generating, as the time when the device will reach the task target location, an amount of time indicating time remaining before the device reaches the task target location.

In some arrangements, projecting the time when the device will reach the task target location within the geographic region includes generating, as the time when the device will reach the task target location, a timestamp indicating a time-of-day at which the device reaches the task target location.

Other embodiments are directed to systems, subsystems, apparatus, assemblies, and so on. Some embodiments are directed to various methods, componentry, platforms, and/or electronic environments/settings/infrastructures/etc. which are involved in providing access to a location based on a current location of a device and a projection as to when the device will reach the location.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a block diagram of an example electronic system that provides access to a location in accordance with certain embodiments.

FIG. 2 is a block diagram of example electronic equipment that provides access to a location in accordance with certain embodiments.

FIG. 3 is a block diagram of an example environment that utilizes the electronic system of FIG. 1 in accordance with certain embodiments.

FIG. 4 is a block diagram of example location data in accordance with certain embodiments.

FIG. 5 is a block diagram of example task data in accordance with certain embodiments.

FIG. 6 is a block diagram of the example environment of FIG. 3 at a first time in accordance with certain embodiments.

FIG. 7 is a block diagram of an example list of tasks in accordance with certain embodiments.

FIG. 8 is a block diagram of the example environment of FIG. 3 at a second time in accordance with certain embodiments.

FIG. 9 is a block diagram of the example environment of FIG. 3 at a third time in accordance with certain embodiments.

FIG. 10 is a flowchart of a procedure for providing access to a location in accordance with certain embodiments.

### DETAILED DESCRIPTION

An improved technique is directed to providing access to a task location based on a current location of a device and a projection as to when the device will reach the task location. Such a technique enables identification of an availability time-window for the task location and smart scheduling of a task to be performed at the task location. Accordingly, such a technique may reduce or eliminate the need for a work crew to wait and/or for equipment to sit idle and waste energy, etc.

For example, within a geographic region such as a golf course, different groups of golfers on the golf course may travel with devices signaling their current locations. Specialized circuitry may then identify paces of play for the golfer groups and where there are gaps between the golfer groups. Such information enables various tasks (e.g., mowing fairways, irrigating holes, other well-defined groundskeeping tasks, combinations thereof, etc.) to be performed within the gaps as the golfer groups progress through the golf course. Accordingly, such techniques improve golf course operations overall since maintenance crews may optimize use of time and equipment as well as easily avoid intruding and interfering with golf play.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

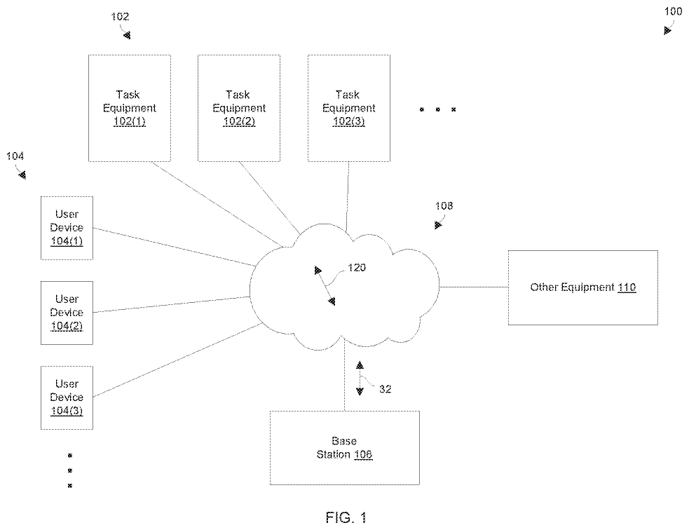

FIG. 1 shows an example electronic system 100 that provides access to a task location within a geographic region in accordance with certain embodiments. The system 100 includes task equipment 102(1), 102(2), 102(3), . . . (collectively, task equipment 102), user devices 104(1), 104(2), 104(3), . . . (collectively, user devices 104), a base station 106, a communications medium 108, and perhaps other equipment 110.

It should be understood that particular details of the example electronic system 100 are described herein in the context of a golf course environment, e.g., a golf course having a sequence of golf course holes played by golfers having different tee times. However, it should be understood that other environments are suitable for use as well and that such other environments may similarly benefit from various advantages offered by the example electronic system 100. Examples of other environments include airports in which equipment/work crews must act between flight arrivals/departures, bus and other types of commuter routes, and warehouses needing maintenance work between deliveries and shipments, among others.

In accordance with certain embodiments, the task equipment 102 is constructed and arranged to perform one or more predefined tasks (or useful work) at one or more locations within a geographic region. In some arrangements, at least some of the task equipment 102 is mobile (i.e., capable of traveling to and/or operating among different locations within the geographic region). In some arrangements, at least some of the task equipment 102 is stationary (i.e., resides within a fixed location) within the geographic region. In some arrangements, some task equipment 102 is mobile and some task equipment 102 is stationary.

In the context of golf courses, example mobile task equipment includes autonomous mowers to autonomously mow tee boxes, fairways, greens, roughs, etc. Example stationary equipment includes irrigation assemblies installed in the ground to irrigate golf course holes.

In the context of an airport, example mobile task equipment includes ground support equipment and other movable resources that may be deployed at different locations to perform various tasks between flights. Other contexts, environments, settings, etc. are suitable as well.

In accordance with certain embodiments, the user devices 104 are constructed and arranged to accompany human users (or other moving apparatus such as vehicles) and communicate with the base station 106. Accordingly, the base station 106 is able to identify current locations of the human users (or the other moving apparatus).

To this end, the user devices 104 may include specialized circuitry such as wireless transceivers for wireless communications, location circuitry (e.g., GPS circuitry, Bluetooth circuitry, other RF circuitry, combinations thereof, and the like), and perhaps other circuitry. The wireless transceivers enable the user devices 104 to communicate information (e.g., location, status, etc.) to the base station 106 and/or receive commands from the base station 106 (e.g., to begin a task, to pause a task, to resume a task, etc.). The location circuitry enables the current locations of the user devices 104 to be determined. The user devices 104 may include other componentry as well such as power supplies, local input and/or output controls, local communications ports, combinations thereof, and so on.

The user devices 104 may take a variety of different form factors (e.g., pocket sized units, clip on or otherwise attachable units, apps running on mobile devices, black boxes, imbedded or integrated circuitry, etc.). Along these lines, in the context of golf course, the golfers on the course may carry the user devices 104 as they play golf on the golf course. Other golfers may place the user devices 104 in (or on) their pull carts. Yet other golfers may ride in drivable golf carts that have the user device 104 installed thereon. Other form factors, integrations, componentizations, mobilizations, etc. are suitable for use based on the particular user and/or environment.

In accordance with certain embodiments, the base station 106 is constructed and arranged to serve as task management hub. Along these lines, the base station 106 is able to communicate with the user devices 104 to identify their various current locations, and then identify one or more tasks that may be performed within one or more availability time-windows existing among (or between) the user devices 104. In some arrangements, the task equipment 102 is constructed and arranged to operate based on commands from the base station 106 and to report status back to the base station 106.

The communications medium 108 is constructed and arranged to connect the various components of the electronic system 100 together to enable these components to exchange electronic signals 120 (e.g., see the double arrow 120). At least a portion of the communications medium 108 is illustrated as a cloud to indicate that the communications medium 108 is capable of having a variety of different topologies including backbone, hub-and-spoke, loop, irregular, combinations thereof, and so on. Along these lines, one or more portions of the communications medium 108 may be wireless and involve the use of wireless data communications devices. Additionally, one or more portions of the communications medium 108 may include copper-based data communications devices and cabling, fiber optic devices and cabling, combinations thereof, and the like. Furthermore, the communications medium 108 is capable of supporting LAN-based communications, SAN-based communications, cellular communications, WAN-based communications, distributed infrastructure communications, other topologies and/or wireless networking technologies, combinations thereof, etc.

The other equipment 110 represents other possible componentry of the electronic system 100 such as clients, servers, websites, specialized equipment, and so on. Along these lines, the other equipment 110 may refer to a user interface for user input/output (I/O), specialized equipment such as that for a golf course (e.g., a tee time scheduling system), and so on.

During operation, the base station 106 communicates with the user devices 104 to identify various current locations of the user devices 104. The base station 106 then identifies one or more tasks that may be performed within one or more availability time-windows existing among (or between) the user devices 104 as the user devices 104 travel through a geographic area.

In some situations, the target task location may be currently available and the availability time-window is bounded simply by when a user traveling with a user device 104 is projected to reach the target task location. In such situations, a set of tasks may be started at the target task location immediately and should finish before the user reaches the target task location.

In other situations, the availability time-window for the target task location may be bounded on both ends, i.e., by a start time when a first user traveling with a first user device 104 is projected to exit the target task location and an end time when a second user traveling with a second user device 104 is projected to reach the target task location. In such situations, a set of tasks may be started at the target task location once the first user leaves the target task location and should finish before the second user enters the target task location.

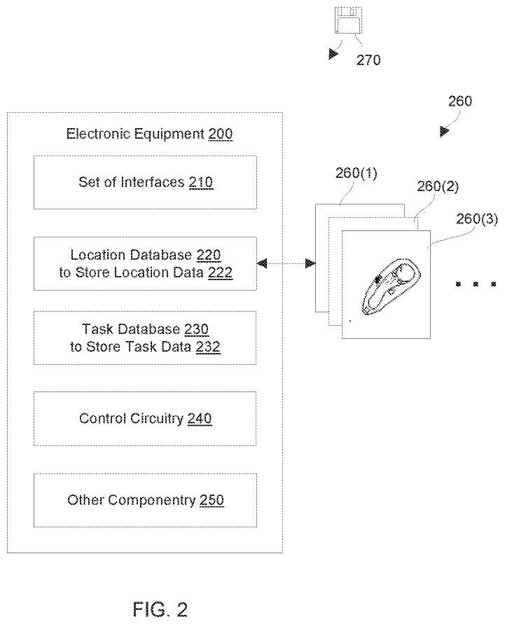

Along these lines and in the context of a golf course, the base station 106 may see that a particular golf course hole will become available (or open) for a period of time (e.g., 20 minutes) between two groups of golfer traveling with respective user devices 104 that signal the current locations of the two groups. The base station 106 may then provide a list of tasks that may be performed at the particular golf course hole during that period of time (e.g., a 15 minute mowing operation to mow the fairway, a 10 minute irrigation operation to irrigate the green, combinations thereof, etc.). Next, the base station 106 (or external specialized control circuitry or a user) may schedule (or launch) one or more tasks on the list of tasks to be performed during the period of time. Such operation reduces or eliminates the need for a maintenance crew to wait and/or for equipment to sit idle and waste energy in a golf course area where there are golfers playing golf. Further details will now be provided with reference to FIG. 2.

FIG. 2 shows electronic equipment 200 that provides access to a task location within a geographic area in accordance with certain embodiments. At least some of the electronic equipment 200 may reside within the base station 106 (FIG. 1). As shown in FIG. 2, the electronic equipment 200 includes a set of interfaces 210, a location database 220 to store location data 222, a task database 230 to store task data 232, control circuitry 240, and other componentry 250.

The set of interfaces 210 enables the electronic equipment 200 to communicate with other components of the electronic system 100. Along these lines, the set of interfaces 210 may include one or more network interfaces (e.g., a wireless transceiver, network card, etc.) to enable the electronic equipment 200 to communicate with other equipment/devices/etc. through the communications medium 108 (also see FIG. 1). The set of interfaces 210 may include other types of interfaces such as specialized or custom circuitry to interface with specialized equipment (e.g., an irrigation system of a golf course).

The location database 220 is constructed and arranged to store location data 222 for a geographic region. That is, the location data 222 defines (or represents) locations within the geographic region.

Along these lines, in the context of a golf course, the location data 222 may include geofencing data (or geofences) 260, i.e., geographic areas defined by virtual boundaries or perimeters. For example, the location database 220 may store, as at least some of the location data 222, a first geofence 260(1) for a first hole of the golf course, a second geofence 260(2) for a second hole of the golf course, a third geofence 260(3) for a third hole of the golf course, and so on.

It should be understood that a geofence 260 for a geographic area may be defined by a grid (or an array of cells/coordinates) of adjacent GPS locations. Here, at least some of the location data 222 represents arrays of GPS locations to define geofences. Some GPS locations may be marked as belonging to the geographic area (i.e., within the geofence 260), and other GPS locations may be marked as not belonging to the geographic area (i.e., outside the geofence 260).

In this example, a user device 104 may report its current GPS location back to the base station 106. Then, when a user device 104 moves into a GPS location that is marked as belonging to the geofence 260 for a geographic area, the base station 106 considers the user device 104 as residing in (or having entered) the geographic area. If the user device 104 moves into another GPS location that is marked as belonging to the geofence 260, the base station 106 considers the user device 104 as still residing in the geographic area. However, when the user device 104 moves out of that GPS location and into a GPS location that marked as not belonging to the geofence 260, the base station 106 considers the user device 104 as no longer being in (or having exited) the geographic area. This example provides certain advantages such as leveraging use of the publicly available GPS infrastructure (e.g., satellite signals), alleviating the need for specialized Bluetooth circuitry, etc.

As another example, such geofences 260 may be defined by Bluetooth beaconing. That is, the location data 222 identifies sets of Bluetooth beacons and/or sets of Bluetooth sensors for different geographic areas. For example, in some Bluetooth beaconing arrangements, a set of the Bluetooth beacons are distributed around a geographic area and a user device 104 is a Bluetooth sensor. While the user device 104 detects at least one of the Bluetooth beacons, the user device 104 communicates such detection to the base station 106 which then considers the user device 104 as residing in (or having entered) the geographic area. When the user device 104 no longer detects at least one of the Bluetooth beacons (e.g., for a predefined amount of time such as 30 seconds), the user device 104 communicates this situation to the base station 106 which then considers the user device 104 as no longer residing in (or as having exited) the geographic area. This example provides certain advantages such as alleviating the need for specialized GPS circuitry.

As another example, in other Bluetooth beaconing arrangements, a set of the Bluetooth sensors is distributed around a geographic area and a user device 104 operates as a Bluetooth beacon. While the set of Bluetooth sensors detects the user device 104 (i.e., the Bluetooth beacon), the set of Bluetooth sensors communicates such detection to the base station 106 which then considers the user device 104 as residing in (or having entered) the geographic area. When the set of Bluetooth sensors no longer detects the user device 104 (e.g., for a predefined amount of time such as 30 seconds), the set of Bluetooth sensors communicates this situation to the base station 106 which then considers the user device 104 as no longer residing in (or as having exited) the geographic area. Again, this example provides certain advantages such as alleviating the need for specialized GPS circuitry.

It should be understood that other geofencing technologies are suitable for use as well. For example, in some embodiments, geographic areas may be associated with RF readers, and the user devices 104 include RFID card technology that can be brought close to the RF readers to inform the base station 106 that the user devices 104 are now entering certain geographic areas. Other embodiment may involve combinations of different geofencing technologies (e.g., GPS, Bluetooth beaconing, RF, etc.), and so on.

The task database 230 is constructed and arranged to maintain task information 232 that defines tasks (or work) to be performed at various locations defined in the location database 220, as well as the amounts of time to perform the tasks. In some arrangements, the amounts of time are maximum or worst case times to perform the tasks based on prior performances of the tasks.

In some arrangements, the amounts of time are adjustable based on a set of factors. For example, for irrigation work, the amounts of time to operate irrigation equipment may be adjusted based on weather conditions (e.g., shorter irrigation times for colder overcast conditions, longer irrigation times for warmer sunnier conditions, etc.). As another example, certain tasks may be provided with additional delays or margins for error such as the maximum times increased by a percentage (e.g., one percent, three percent, five percent, etc.) to enable users traveling with the user devices 104 to move clear of the areas before tasks are initiated. Other margins, worse case metrics, variance factors, etc. are suitable for use as well.

The control circuitry 240 of the electronic equipment 200 is constructed and arranged to perform one or more operations involved in providing access to a task target location within a geographic region. Such operation may include receiving a signal through the set of interfaces and, from the signal, identifying a current location of a user device 104 traveling with a set of users (e.g., a group of golfers). Additionally, such operation may include generating, based on the current location of the user device 104, a time at which the user device 104 is projected to reach a task target location (e.g., a number of minutes until the user device 104 will reach the location, a timestamp indicating a time of day at which the user device 104, will reach the location, combinations thereof, etc.). Furthermore, such operation may include electronically providing, based on the generated time, an availability time-window for performing a task at the task target location before the user device 104 reaches the task target location.

Such operation enables the control circuitry 240 to identify one or more tasks that can be performed at the task target location within the availability time-window before the user device 104 traveling with an approaching set of users reaches the task target location. Accordingly, there is no disruption or interference with user activity.

In some arrangements, the availability time-window is a time gap that is bounded by both a start time and an end time. In such arrangements, the control circuitry 240 projects when another set of users ahead of the approaching set of users is projected to leave the task target location in order to identify the start time.

In some arrangements, the control circuitry 240 communicates commands to the task equipment 102 through the set of interfaces 210. Such commands may direct the task equipment 102 to initiate tasks, pause tasks, resume tasks, and so on.

It should be appreciated that the control circuitry 240 may be implemented in a variety of ways such as via one or more processors (or cores) running specialized software stored in non-volatile memory, application specific ICs (ASICs), field programmable gate arrays (FPGAs) and associated programs, discrete components, analog circuits, other hardware circuitry, combinations thereof, and so on. In the context of one or more processors (and/or other types of computerized circuitry) executing software, a computer program product 270 is capable of delivering all or portions of the specialized software to the electronic equipment 200. In particular, the computer program product 270 includes a non-transitory (or non-volatile) computer readable medium which stores a set of instructions that controls one or more operations of the electronic equipment 200. Examples of suitable computer readable storage media include tangible articles of manufacture and apparatus which store instructions in a non-volatile manner such as DVD, CD-ROM, flash memory, disk memory, tape memory, combinations thereof, and the like.

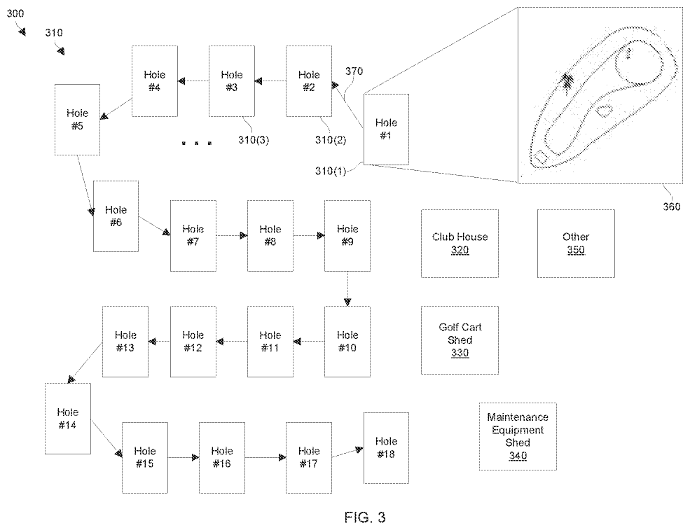

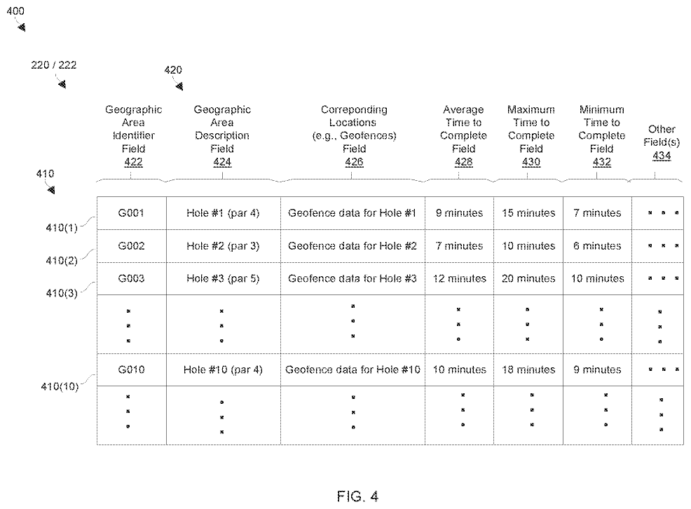

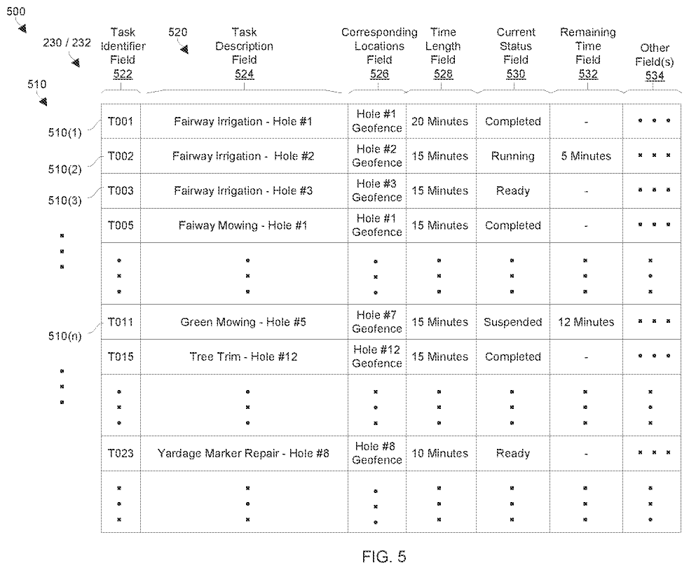

The other componentry 250 of the electronic equipment 200 refers to additional features/components that may belong to the electronic equipment 200. Along these lines, the electronic equipment 200 may have a time clock, a local set of user input/output (I/O) devices (e.g., a touchscreen, a keyboard, a mouse, a microphone, LEDs, a speaker, etc.), and so on. Further details will now be provided with reference to FIGS. 3 through 5. FIG. 3 shows a view of an example geographic region (or environment) 300 that utilizes the electronic system 100 of FIG. 1 to provide access to a task location in accordance with certain embodiments. FIG. 4 shows a view 400 of example location data 222 for a location database 220 (also see FIG. 2) which is utilized by the electronic system 100 in accordance with certain embodiments. FIG. 5 shows a view 500 of example task data 232 for a task database 230 (also see FIG. 2) which is utilized by the electronic system 100 in accordance with certain embodiments.

As shown in FIG. 3, the geographic region 300 includes a sequence of geographic areas 310(1), 310(2), 310(3), . . . (collectively, geographic areas 310) through which users travel with the user devices 104 (also see FIG. 1). Along these lines, users may proceed through the sequence of geographic areas 310 beginning at one end of the sequence until they reach the other end. During such travel, the electronic system 100 may identify availability time-windows within which one or more tasks may be performed without interfering with the users.

In accordance with certain embodiments, the geographic areas 310 reside within geofences 260 defined by location data 222 within the location database 220 (also see FIG. 2). As mentioned earlier, such a geofence 260 is a geofenced area (or zone), i.e., a geographic area defined by a virtual boundary or perimeter. Accordingly, the electronic system 100 is able to monitor current locations of the user devices 104 as the users travel with the user devices 104 and identify where the user devices 104 are currently located with respect to the geofenced geographic areas 310.

In the context of a golf course, the geographic region 300 includes, as the geographic areas 310, a sequence (or order) of golf course holes (e.g., Hole #1 through Hole #18) on which golfers progress with the user devices 104 while playing golf. The golf course may include other premises/locations such as a club house 320 (e.g., pay, shop for golf items, etc.), a golf cart shed 330 (e.g., to service, dispatch and receive golf carts), a maintenance equipment shed 340 (e.g., to service, dispatch and receive maintenance equipment), and perhaps other sections 350 (e.g., a practice green, a driving range, a restaurant, etc.).

The inset 360 in FIG. 3 shows that a golf course hole (e.g., Hole #1) may include a variety of sub-areas such as a tee box, a fairway, a green, a rough, and so on. Accordingly, an amount of time is required for a set of golfers (e.g., one to four golfers) to play a golf course hole. That is, hole play starts by teeing off, playing through the fairway, and finishing with putting to a pin (e.g., into a cup). In fact, over time, the golf course may track golfing performance at each hole to determine a worst case amount of time for a set of golfers to play that hole, an average amount of time, a best case amount of time, and so on.

Once a first set of golfers finishes with Hole #1 (see geographic area 310(1) in FIG. 3), the first set of golfers proceeds to play Hole #2 (see geographic area 310(1) in FIG. 3). This progress is illustrated by the arrow 370 in FIG. 3. At that time and if ready, a second set of golfers may begin Hole #1. Likewise, once the first set of golfers finishes with Hole #2, the first set of golfers proceeds to play Hole #3 (see geographic area 310(3) in FIG. 3). At that time and if ready, the second set of golfers may begin Hole #2, and so on.

It should be appreciated that instances may arise in which there are windows of time (or gaps) between sets of golfers playing on the golf course. Such windows of time may be created by open (i.e., unused) tee times, slow play by one or more sets of golfers, events (e.g., groups of golfers stopping to rest or to buy food from a traveling food cart, etc.), and so on.

Moreover, while the golfers play golf on the golf course, the golfers travel the golf course with respective user devices 104 thus enabling the electronic system 100 to electronically track their locations. Accordingly, the electronic system 100 is able to identify availability time-windows between the sets of golfers playing on the golf course.

It should be understood that, in some arrangements, multiple golfers may share (or travel) with a single user device 104. For example, a golf cart carrying two golfing passengers may be equipped with a user device 104 on board.

Furthermore, the electronic system 100 is capable of managing tasks that are to be performed at various locations during the day (e.g., see the task database 230 in FIG. 2). From the tasks that are to be performed, the electronic system 100 is able to list particular tasks that fit within and that can be scheduled during the availability time-windows between sets of golfers playing on the golf course.

FIG. 4 shows a view 400 of example location data 222 for an example geographic region 300 (also see FIG. 3) in accordance with certain embodiments. The electronic system 100 maintains the location data 222 within the location database 220 (FIG. 2) and uses the location data 222 when providing access to a task location based on a current location of a user device 104.

As shown in FIG. 4, the location data 222 includes multiple geographic area entries 410(1), 410(2), 410(3), . . . , (collectively, geographic area entries 410). The geographic area entries 410 include various fields 420 such as geographic area identifier fields 422, geographic area description fields 424, corresponding location fields 426, average time to complete fields 428, maximum time to complete fields 430, minimum time to complete fields 432, and other fields 434.

The geographic area identifier fields 422 of the entries 410 hold geographic area identifiers that uniquely identify particular geographic areas. Such geographic area identifiers may be used as values or keys to distinguish the entries 410 from each other and for lookups/searching. For example, in the context of a golf course, the geographic area identifiers may uniquely identify different golf course holes (or smaller regions within the golf course holes such as putting greens, portions of the fairways, etc.).

The geographic area description fields 424 hold descriptions of the geographic areas. Along these lines, in the golf course example, the contents of the description field 424 for the entry 410(1) indicates that the entry 410(1) is for Hole #1 on the golf course. Similarly, the contents of the description field 424 for the entry 410(2) indicates that the entry 410(2) is for Hole #2, and so on. The description fields 424 may hold other types of information which is useful to a human operator (e.g., par for a golf course, etc.).

The corresponding locations fields 426 hold corresponding location data for the entries 410 (i.e., data identifying the locations corresponding to the geographic areas). In some arrangements, the corresponding locations fields 426 hold pointers, links, or other references to other software constructs or objects such as arrays of locations for geofences. For the golf course example, the contents of the corresponding locations field 426 of entry the 410(1) identifies geofence data for Hole #1. Furthermore, the contents of the corresponding locations field 426 of the entry 410(2) identifies geofence data for Hole #2, and so on.

The average time to complete fields 428 hold average time values or amounts (e.g., averages of actual time measurements) indicating the average amounts of time users reside at the geographic areas. For the golf course example, the contents of the average time to complete field 428 of the entry 410(1) indicates that the average time for a golfer to fully play (or complete) Hole #1 is 9 minutes. Additionally, the contents of the average time to complete field 428 of the entry 410(2) indicates that the average time for a golfer to fully play Hole #2 is 7 minutes, and so on.

The maximum time to complete fields 430 hold maximum time values (e.g., worst case time measurements) indicating the worst case amounts of time users reside at the geographic areas. For the golf course example, the contents of the maximum time to complete field 430 of the entry 410(1) indicates that the maximum time for a golfer to fully play Hole #1 is 15 minutes. Additionally, the contents of the maximum time to complete field 430 of the entry 410(2) indicates that the maximum time for a golfer to fully play Hole #1 is 10 minutes, and so on.

The minimum time to complete fields 432 hold minimum time values (e.g., best case time measurements) indicating the best case amounts of time users reside at the geographic areas. For the golf course example, the contents of the minimum time to complete field 430 of the entry 410(1) indicates that the minimum time for a golfer to fully play Hole #1 is 7 minutes. Additionally, the contents of the maximum time to complete field 430 of the entry 410(2) indicates that the maximum time for a golfer to fully play Hole #1 is 6 minutes, and so on.

The other fields 434 of the entries 410 are suitable for holding other or additional information for the geographic areas. Such other or additional information may enable one or more of the time values in the time fields 428, 430 and 432 to be adjusted based on various factors. Along these lines, in the golf course example, the other fields 434 may include variance metrics that enable the various time fields 428, 430 and 432 to be adjusted based on factors such as public play vs. league play, weather conditions, the number of golfers (e.g., the size of the golf group), whether the golfers are walking or riding on golf carts, pace of play, time of day, and so on. Additionally or alternatively, the location data 222 may be augmented to have different metrics based on the various factors.

It should be appreciated that, with the location data 222, particular projections may be generated or derived. Along these lines, in the example of FIG. 4, the average time it takes a user to travel through the series of geographic areas G001, G002, and G003 is 9 minutes, 7 minutes, and 12 minutes, respectively. Accordingly, the average time it takes a user to travel through all three geographic areas G001, G002, and G003 is 28 minutes as derived by summing the time amounts to fully complete the three geographic areas G001, G002, and G003.

Average times for a user to travel through other series of geographic areas (at least two adjacent geographic areas in the sequence) may be generated in the same manner. Moreover, worst case and best case times over a series of geographic areas may be generated in the same manner. Further task details will now be provided with reference to FIG. 5.

FIG. 5 shows a view 500 of example task data 232 for an example geographic region 300 (also see FIG. 3) in accordance with certain embodiments. The electronic system 100 maintains the task data 232 within the location database 220 (FIG. 2) and uses the task data 232 when providing access to a task location based on a current location of a user device 104.

As shown in FIG. 5, the task database 230 includes multiple task entries 510(1), 510(2), 510(3), . . . , 310(n), . . . (collectively, task entries 510). The task entries 510 include various fields 520 such as task identifier fields 522, task description fields 524, geofenced area fields 526, start time fields 528, irrigation length (or time) fields 530, current status fields 532, remaining irrigation time fields 534, and other fields 536.

The task identifier fields 322 of the task entries 510 hold task identifiers that uniquely identify various tasks to be performed within the geographic region 300. Such task identifiers may be used as values or keys to distinguish the entries 510 from each other. For example, in the context of a golf course, the geographic area identifiers may uniquely identify different groundskeeping tasks such as mowing tasks to mow different golf course holes (or smaller regions within the golf course holes such as portions of the fairways, putting greens, etc.), different irrigation tasks to irrigate different golf course holes (or regions), and so on.

The task description fields 524 hold descriptions of various tasks to assist understanding by a human operator. Along these lines, in the golf course example, the contents of the description field 524 for the entry 510(1) indicates that the entry 510(1) defines a task to irrigate the fairway of Hole #1 on the golf course. Similarly, the contents of the description field 524 for the entry 510(2) indicates that the entry 510(2) defines a task to irrigate the fairway of Hole #2, and so on. Other descriptions that are suitable for golf course tasks include mowing (e.g., by a set of autonomous mowers), vegetation trimming, yardage marker maintenance/repair, and so on.

The corresponding locations fields 526 hold corresponding location data for the task entries 510 (i.e., data identifying the locations corresponding to the geographic areas for the tasks). In some arrangements, as with similar fields in the location data 222, the corresponding locations fields 526 hold pointers, links, or other references to other software constructs or objects such as arrays of locations for geofences. For the golf course example, the contents of the corresponding location field 526 of the entry 510(1) identifies geofence data for Hole #1. Furthermore, the contents of the corresponding location field 526 of the entry 510(2) identifies geofence data for Hole #2, and so on.

The time length fields 428 hold time values for performing the tasks in the geographic areas identified by the corresponding locations fields 526. These amounts of time are the full amounts of time to complete the tasks from beginning to end. For the golf course example, the contents of the time length field 528 of the entry 510(1) indicates that the amount of time for an irrigation assembly to irrigate Hole #1 is 20 minutes. Additionally, the contents of the time length field 528 of the entry 510(2) indicates that the amount of time for an irrigation assembly to irrigate Hole #2 is 15 minutes, and so on.

The current status fields 530 hold status for the tasks such as ready, running (or currently being performed), completed, suspended and so on. For the golf course example, the contents of the current status field 530 of the entry 510(1) indicates that the task to irrigate the fairway of Hole #1 has been completed. Additionally, the contents of the current status field 530 of the entry 510(2) indicates that the task to irrigate the fairway of Hole #2 is currently underway (or running), the contents of the current status field 530 of the entry 510(3) indicates that the task to irrigate the fairway of Hole #3 is ready to be performed, and so on.

The remaining time fields 530 hold remaining amounts of time for the tasks. For example, the electronic system 100 may pause a task (e.g., due to manual pausing by an operator, due to unexpected/projected real-time detection of a user traveling with a user device 104 entering a location of a currently running task, etc.). Once the task is resumed (e.g., by manually unpausing the task, due to automatic resuming when the user leaves the corresponding locations for the task within an identified availability time-window, due to re-scheduling of the task based on the remaining time rather than the full amount of time for the task, etc.), the electronic system 100 tracks the status of the task through to completion during the remaining time, etc.

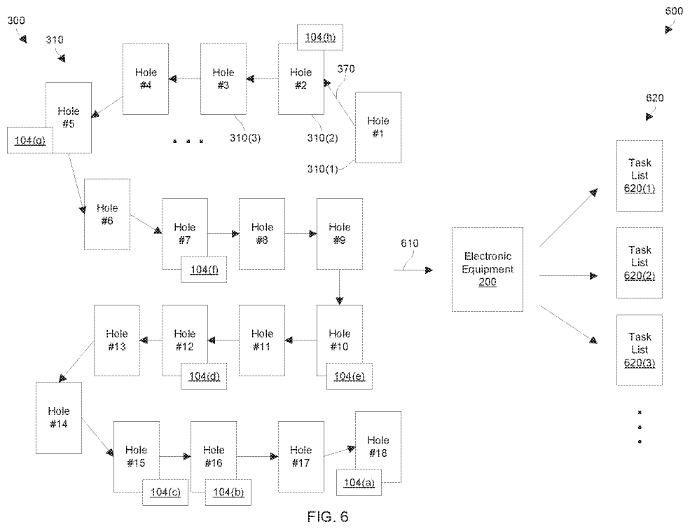

The other fields 534 of the entries 510 are suitable for holding other or additional information for the geographic areas. Such other or additional information may include enhancements, options, special conditions, and so on. Along these lines, the various tasks may be assigned a level of importance (e.g., high, average, low) enabling tasks for a location to be ranked by priority relative to each other. Additionally, the contents of certain fields 534 may indicate that particular tasks should only be performed on particular days (e.g., weekdays, M-W-F, etc.) or during particular times of the day (e.g., mornings, late afternoons, etc.), when certain groundskeepers are working that day, when it is not raining, and so on. Further details will now be provided with reference to FIGS. 6 through 9.

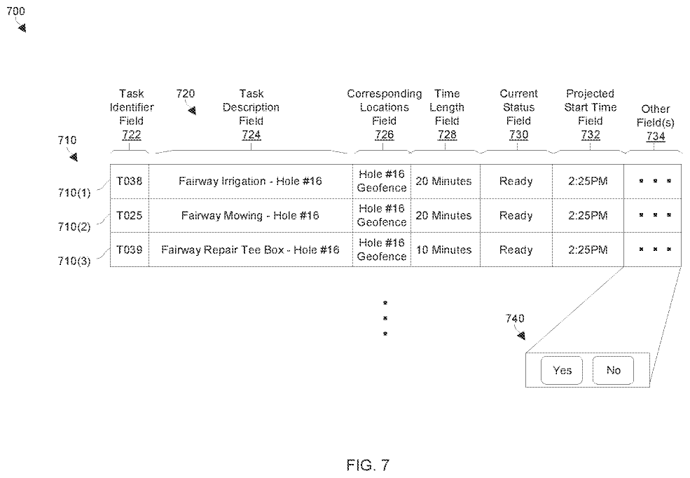

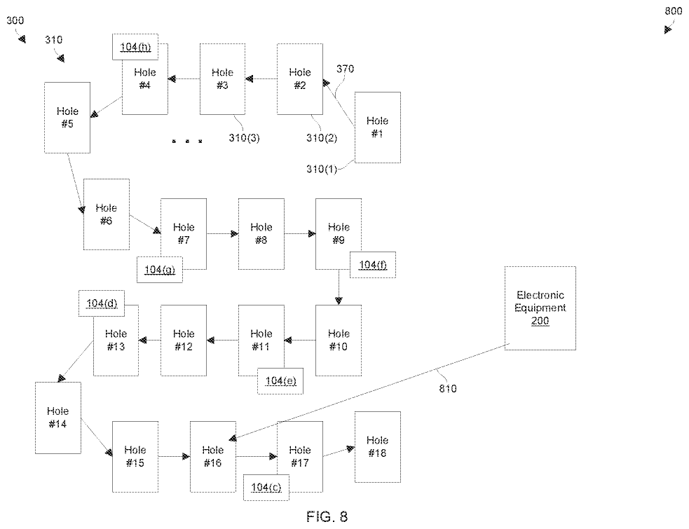

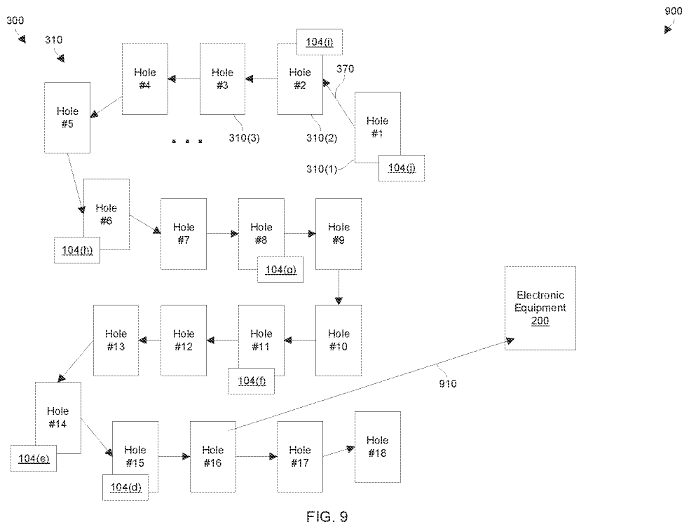

FIGS. 6 through 9 show, in accordance with certain embodiments, certain details for the electronic system 100 (FIG. 1) during operation. FIG. 6 shows a view 600 of the example geographical region 300 (FIG. 3) while there are users traveling with user devices 104 within the geographical region 300 at a first time. FIG. 7 shows an example task list generated by the electronic system 100 based on current locations of the user devices 104. FIG. 8 shows a view 800 of the example geographical region 300 (FIG. 3) while there are users traveling with user devices 104 within the geographical region 300 at a second time after the first time. FIG. 9 shows a view 900 of the example geographical region 300 (FIG. 3) while there are users traveling with user devices 104 within the geographical region 300 at a third time after the second time.

As shown in FIG. 6, various users are traveling through the geographical region 300 with respective user devices 104 identifying current locations. As mentioned earlier, the geographic region 300 is shown as a golf course by way of example. Accordingly, the users are golfers traveling in sets (or groups), typically one to four golfers in each set.

For simplicity, suppose that each set of golfers travels with a single user device 104. Along these lines, a first set of golfers is currently playing on Hole #18 and traveling with a user device 104(a). Additionally, a second set of golfers is currently playing on Hole #16 and traveling with a user device 104(b). Furthermore, a third set of golfers is currently playing on Hole #15 and traveling with a user device 104(c), and so on. Nevertheless, each set of golfers may travel with more than a single user device (e.g., a foursome of golfers may share two user devices 104 when riding in two golf carts with integrated user devices 104, walking golfers may individually travel with respective user devices 104, etc.).

During operation and still with reference to FIG. 6, the electronic equipment 200 (FIG. 2) of the electronic system 100 receives signals 610 indicating the current locations of the user devices 104. It should be appreciated that the manner in which the signals 610 are received may be based on the available infrastructure(s). For example, in an embodiment in which the user devices 104 remotely detect and output GPS locations, the user devices 104 may transmit wireless signals carrying location information to a set of antennae (e.g., cell towers, wireless network devices, combinations thereof, etc.) that then convey the GPS locations to the electronic equipment 200. As another example, in an embodiment in which the Bluetooth sensors are distributed among the geographic areas 310, the Bluetooth sensors may transmit signals (e.g., wirelessly, over copper lines, combinations thereof, etc.) to the electronic equipment 200. Other communication situations are suitable for use as well (e.g., RF readers, laser scanners, infrared detectors, other wireless/remote communication technologies, combinations thereof, etc.).

In some arrangements, the electronic equipment 200 includes a front end to initially process the signals 610 into location data and a back end to generate a set of availability time-windows for performing tasks as well as initiate the tasks. Such a front end may be handled by a first service or circuit (e.g., first specialized circuitry that manages a fleet of user devices 104 to report geolocations), and such a back end may be handled by a second service or circuit (e.g., second specialized circuitry that fits tasks into the availability time-windows for scheduling, execution, etc.).

From the current locations of the user devices 104, the electronic equipment 200 is able to dynamically track/monitor where the users (e.g., golfers) are in the geographic region 300 (e.g., the golf course) over time. Additionally, the electronic equipment 200 is able to derive various metrics regarding user travel such as pace or travel rate (e.g., fast, average, slow), special conditions (e.g., lost, off track, detoured, suspended, waiting, falling behind, etc.), and so on.

With such metrics, the electronic equipment 200 then generates projections for availability time-windows at various geographic areas 310 within which various tasks can be performed. Such availability time-windows occur between sets of users as the sets of users travel through the geographic region 300. By performing the tasks at the geographic areas 310 during the availability time-windows, there is no interference imposed on the sets of users. Accordingly, such operation improves the user experience, saves resources (e.g., reduces or eliminates idle time, avoids wasting gas/energy, etc.) as well as enables work to be performed reliably and effectively in a routine amount of time without rushing, constant interruption, etc.

Along these lines, the electronic equipment 200 is constructed and arranged to provide task lists 620(1), 620(2), 620(3), . . . (collectively, task lists 620) enabling smart access to various locations among the geographic region 300. To this end, the task list 620(1) may be a list of tasks that can be performed at a first target task location (e.g., Hole #4), the task list 620(2) may be another list of tasks that can be performed at a second target task location (e.g., Hole #11), the task list 620(3) may be a list of tasks that can be performed at a third target task location (e.g., Hole #16), and so on. Accordingly, the electronic equipment 200 is able to manage access to multiple task target locations simultaneously.

For example, suppose the task database 230 indicates that there are multiple tasks that are ready to be performed at Hole #16 and that sets of golfers are currently playing golf on the golf course as shown in FIG. 6. Along these lines, suppose that the electronic equipment 200 identifies a first group of golfers on Hole #15 via the user device 104(c) and a second group of golfers immediately after the first group on Hole #12 via the user device 104(d). Moreover, suppose that the electronic equipment 200 has monitored the rate at which both groups have been moving through the holes of the golf course (i.e., their pace of play), and determined that the both groups are moving at the same pace or that the space between groups is slightly growing because the second group is playing at a slightly slower pace of play.

Based on such location information from the user devices 104 and the location database 220 (FIG. 2), the electronic equipment 200 may ascertain upcoming availability time-windows for performing tasks at various geographic areas 310 within the geographic region 300. Along these lines, the electronic equipment 200 may generate a projection that the Hole #16 will be available for a task in approximately 15 minutes once the first group, which is about to finish Hole #15, starts and finishes Hole #16. In particular, the electronic equipment 200 may access entries in location database 220 (FIG. 2) to ascertain how long the first group will take to play Hole #15 and Hole #16. Such a determination may be based on one or more amounts of time stored in the time fields of the entries 410 corresponding to Hole #15 and Hole #16 (e.g., see the example location data 222 in FIG. 4).

Which amounts of time (e.g., best cast, average, worst case, etc.) may be based various factors such as the number of golfers in the group, environmental factors (e.g., weather, course conditions, etc.), whether the golfers are walking or riding, etc. For example, if there are two golfers in the first group, the electronic equipment 200 may use the average times. If there are four golfers in the first group, the electronic equipment 200 may use the worst case times. If there is only one golfer riding a golf cart, the electronic equipment 200 may use the best case times, etc.

In a similar manner, the electronic equipment 200 may further ascertain that Hole #16 will no longer be available for a task in approximately 45 minutes once the second group, which is about to finish Hole #12, reaches Hole #16. That is, the electronic equipment 200 again accesses the location database 220 to project when the second group of golfers will reach Hole #16.

Based on these time projections, the electronic equipment 200 provides an upcoming availability time-window for a task at Hole #16 that will last for 30 minutes. This availability time-window is a time gap between the first and second groups of golfers traveling with the user devices 104(c) and 104(d) (see FIG. 6). In particular, the availability time-window is bounded by a start time when the user device 103(c) is projected to leave the Hole #16 geographic area 310 and an end time when the user device 103(d) is projected to reach the Hole #16 geographic area 310.

It should be understood that the electronic equipment 200 may operate using relative times. For example, the electronic equipment 200 may consider that the start time for the availability time-window is in 15 minutes, and that the end time for the availability time-window is in 45 minutes.

Alternatively, the electronic equipment 200 may operate using absolute times (e.g., timestamps indicating a time of day). For example, if the current time of day is 1:08 pm, the electronic equipment 200 may consider that the start time for the availability time-window is 1:23 pm, and that the end time for the availability time-window is 1:53 pm.

Both techniques define an upcoming availability time-window or time gap of 30 minutes at Hole #16 which can be filled with a task lasting no more than 30 minutes. Moreover, the electronic equipment 200 understands that the upcoming availability time-window at Hole #16 is projected to occur in 15 minutes.

After the electronic equipment 200 generates the availability time-window, the electronic equipment 200 searches the task database 230 (FIG. 5) to identify a set of tasks that can be performed during the availability time-window. Along these lines, the electronic equipment 200 may search the task database 230 for entries 410 representing candidate tasks and eliminate various tasks due to certain factors (e.g., completed or already performed, not the correct geolocation, too long, equipment not present today, etc.). In some arrangements, the electronic equipment 200 applies margin (e.g., an extra safety factor amount of time to enable users to completely leave the area before the task begins) to the task times before considering whether the tasks fit within the availability time-window.

Once the electronic equipment 200 identifies the particular candidate tasks that can be performed (or resumed) in the availability time-window, the electronic equipment 200 ranks (or orders) the particular candidate tasks on the list 700. Such ranking may be based on pre-assigned levels of importance (e.g., high, average, low), whether a task has been partially performed and simply needs to be resumed, combinations thereof, and so on.

In some embodiments, the electronic equipment 200 automatically allocates the first task on the ranked task list to the availability time-window so that the first task is performed during the availability time-window. In some embodiments, the electronic equipment 200 prompts an operator for permission/confirmation before initiating or launching the task.

In other embodiments, the electronic equipment 200 provides the task list to the operator and enables the operator to select which task to perform during the availability time-window from the task list. Along these lines, the electronic equipment 200 may display the task list in a user interface (e.g., graphical user interface or GUI) that enables an operator to perform user input/output (I/O).

FIG. 7 is a view 700 of a sample task list 620 that is generated by the electronic equipment 200 in accordance with certain embodiments (also see FIG. 6). The task list 700 includes list entries 710(1), 710(2), 710(3), . . . (collectively, list entries 710). The list entries 710 have fields 720 including task identifier fields 722, task description fields 724, geofenced area fields 726, time length fields 728, current status fields 730, projected start time fields 732, and other fields 734.

The task identifier fields 722 of the list entries 710 hold task identifiers that uniquely identify the various tasks on the task list 700. Such task identifiers may be used as values or keys to distinguish the entries 710 from each other. In some arrangements, the task identifiers in the task identifier fields 722 are the same as the task identifiers used for the task entries 510 in the task database 230 (also see FIG. 5).

The task description fields 524 hold descriptions of various tasks. Along these lines, in the golf course example, the contents of the description field 724 for the entry 710(1) indicates that the entry 710(1) is to irrigate the fairway of Hole #16. Similarly, the contents of the description field 724 for the entry 710(2) indicates that the entry 710(2) is to mow the fairway of Hole #2, and so on. Other descriptions that are suitable for golf course tasks include mowing, vegetation trimming, yardage marker maintenance/repair, and similar groundskeeping tasks, among others.

The corresponding locations fields 726 hold corresponding location data for the entries 710 (i.e., data identifying the locations corresponding to the geographic areas for the tasks). Here, since the task list 700 is for tasks to be performed on Hole #16, the contents identify Hole #16.

The time length fields 728 hold time values for performing the tasks in the geographic areas identified by the corresponding locations fields 726. These amounts of time are the amounts of time to complete the tasks (e.g., from beginning to end, from being resumed, etc.). For example, the contents of the time length field 728 of the entry 710(1) indicates that the amount of time for an irrigation assembly to irrigate the fairway of Hole #16 is 20 minutes. Additionally, the contents of the time length field 728 of the entry 710(2) indicates that the amount of time for an autonomous mower to mow the fairway of Hole #16 is 20 minutes, and so on.

The current status fields 530 hold status for the tasks such as ready, etc. In some arrangements, the task list 700 may monitor and/or manage tasks that have been temporarily paused (e.g., paused manually, suspended due to a stray user device 104 entering the geographic area, etc) and which may be resumed during the availability time-window.

The other fields 734 of the entries 710 are suitable for holding other or additional information for the tasks on the task list 700. Along these lines, when the task list 700 is rendered to an operator (e.g., in a GUI), the operator may be presented with a control interface 740 (e.g., window or menu having “Yes” and “No” buttons) that enables the operator to enter commands directing which task or tasks to perform during the availability time-window. Such a feature enables the operator assign a lower level (or lower priority) task to the availability time-window rather than the highest level task.

In some arrangements, the electronic equipment 200 may assign more than one task to an availability time-window. Along these lines, some tasks may be performed concurrently (e.g., irrigating a fairway and a putting green of a golf course hole). Additionally, some tasks may be performed serially (e.g., mowing a fairway and then irrigating the fairway).

It should be understood that, as soon as the first group of golfers exits Hole #16, the electronic equipment 200 may consider Hole #16 available for performing a task. In some arrangements, the electronic equipment 200 starts/initiates an assigned task as soon as the geographic area is open. In other arrangements, the electronic equipment 200 waits a predefined amount of time (e.g., 30 seconds, a minute, etc.) before starting the task.

FIG. 8 shows a view 800 of the example geographical region 300 after the users traveling with the user device 104 have progressed through the geographic region 300 for another 15 minutes. That is, FIG. 6 now shows the locations of the users devices 104 15 minutes earlier, and FIG. 8 now shows the current locations of the user devices 104.

As shown in FIG. 8, the first group golfers traveling with the user device 104(c) has just left Hole #16, and the second group of golfers traveling with the user device 104(d) is just about to finish Hole #13. The other groups of golfers have progressed through the geographical region 300 as well.

The electronic equipment 200 considers availability time-windows to perform tasks at target task locations to begin when all user devices 104 have left the target task locations. For example, in connection with Hole #16 as a target task location, the electronic equipment 200 considers the availability time-window to perform a task at Hole #16 to start when the user device 104(c) leaves Hole #16 and there are no other user devices 104 at Hole #16.

At this point, the task that has been assigned to Hole #16 may launch as illustrated by the arrow 810. Along these lines, the electronic equipment 200 may electronically connect with an irrigation system (e.g., see the set of interfaces 210 in FIG. 2), and direct the irrigation system to operate irrigation equipment (e.g., pumps, valves, irrigation heads, etc.) to irrigate the fairway of Hole #16 during the availability time-window.

In some arrangements, the electronic equipment 200 considers the first group of golfers to have left Hole #16 when the user device 104(c) no longer resides in a geofence corresponding to Hole #16. In other arrangements, the electronic equipment 200 considers the first group of golfers to have left Hole #16 when the user device 104(c) enters a geofence corresponding to Hole #17. In some situations, the electronic equipment 200 waits a predefined amount of time (e.g., 30 seconds, a minute, etc.) before deeming the first group of golfers to have left Hole #16 as a safeguard, e.g., in case the golfers are looking for a lost ball.

It should be understood that an irrigation task is described by way of example and that other tasks are suitable as well. Along these lines, instead or in addition to the irrigation task, the electronic equipment 200 may initiate a mowing task if such a groundskeeping task is appropriate based on timing, based on logistics, based on combining with one or more other tasks, and so on. For example, the electronic equipment 200 may send a command to an autonomous mower that has been dispatched to the putting green of Hole #16 and the autonomous mower may mow the putting green of Hole #16 while the irrigation system irrigates the fairway of Hole #16.

In some embodiments, the electronic equipment 200 pauses a task that has been started if the electronic equipment 200 detects a user device 104 entering a geofenced area with a task in progress. Such operation provides safety, improves the user experience, and so on.

Once the user device 104 exits the geofenced area, the electronic equipment 200 may resume the task if there is suitable time remaining. Alternatively, the electronic equipment 200 may update the status of the task in the task database 230 and wait for another large-enough availability time-window to arise in order to resume the task. For example, the electronic equipment 200 may resume irrigation for Hole #16 during available time gaps to complete irrigation in as tight a timeframe as possible to avoid excessive evaporation. However, the electronic equipment 200 may delay resuming a mowing task until there is sufficient time to complete the mowing task in one time gap so that the mowing equipment can mow an adjacent golf course hole during the interim, and so on.

FIG. 9 shows a view 900 of the example geographical region 300 after another 30 minutes. That is, FIG. 8 now shows the locations of the users devices 104 30 minutes earlier, and FIG. 9 now shows the current locations of the user devices 104.

As shown in FIG. 9, the first group golfers traveling with the user device 104(c) has left the golf course, and the second group of golfers traveling with the user device 104(d) is playing Hole #15. The other groups of golfers have progressed through the geographical region 300 as well.

Here, the electronic system 100 has successfully completed a task at a target task location (e.g., Hole #16) without interfering with users traveling with the user devices 104 through the geographic region 300. When the task completes, the electronic equipment 200 updates the task data 232 in the task database 230 (FIG. 5) as illustrated by the arrow 910. Accordingly, if there are other tasks to be performed at the same target task location, the electronic equipment 200 is able to identify and assign one or more new appropriate tasks to be performed at the target task location during the next availability time-window.

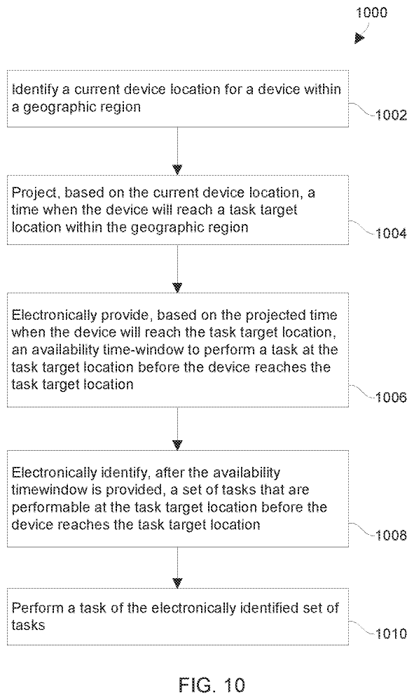

It should be understood that the electronic system 100 is capable of providing access to multiple target locations within a geographic region 300 simultaneously. For example, in the example golf course context, another set of tasks may be provided for Hole #4 as a second target task location, yet another set of tasks may be provided for Hole #8 as a third target task location, and so on. In fact, the electronic system 100 may support concurrently managing access to each area identified in the location database 220 (e.g., every golf course hole of the golf course). Further details will be provided with reference to FIG. 10.

FIG. 10 is a flowchart of a procedure 1000 for providing access to a task location in accordance with certain embodiments. The procedure 1000 may be performed by specialized equipment such as the electronic equipment 200 (also see FIG. 2).

At 1002, the specialized equipment identifies a current device location for a device within a geographic region. Along these lines, the electronic equipment 200 identifies current locations of user devices 104 that travel with sets of users among the geographic region 300.

At 1004, the specialized equipment projects, based on the current device location, a time when the device will reach a task target location within the geographic region. Such a projection can be based on location data accessed from a location database indicating how long such a device takes to travel among one or more locations within the geographic region.

At 1006, the specialized equipment electronically provides, based on the projected time when the device will reach the task target location within the geographic region, an availability time-window to perform a task at the task target location before the device reaches the task target location. The availability time-window may be viewed as a time gap within which a task may be performed at the task target location. In some arrangements, the time gap is further bounded by a start time at which another device (e.g., traveling with another set of users) is projected to leave the task target location.

At 1008, the specialized equipment electronically identifies, after the availability time-window is provided, a set of tasks which are performable at the task target location before the device reaches the task target location. Along these lines, the electronic equipment 200 may search a task database for tasks that can be completed before the device is projected to reach the task target location.

At 1010, the specialized equipment performs a task of the electronically identified set of tasks. In some arrangements, the task is launched or started as soon as the task target location becomes available. In other arrangements, the task is launched or started after allowing a predefined amount of time to pass (e.g., to allow users to move some distance from the task target location before the task starts). Since the task will be performed before the approaching device reaches the task target location, there is no interference with a user traveling with that device. Moreover, any equipment involved in performing the task can be applied efficiently without idling wastefully.

As described above, improved techniques are directed to providing access to task locations based on current locations of devices 104 and projections as to when the devices 104 will leave and/or reach the task locations. Such techniques enable identification of availability time-windows at the task locations and smart assignment and/or scheduling of tasks to be performed at the task locations. Accordingly, tasks may be performed optimally rather than wastefully at the task locations and without causing interference, disruption, etc. (e.g., work crews do not need to wait and/or equipment does not need to sit idle wasting energy, etc.).

One should appreciate that the above-described techniques do not merely provide scheduling of tasks. Rather, the disclosed techniques provide certain advantages and/or benefits. Along these lines, deployment of user devices 104 traveling with users through a geographic region 300 enables accurate location identification as well as competent projection of pace (or rate of progress) through the geographic region. Such operation is impossible or impractical to do manually due to the amount of time, effort, and accuracy required. For example, when there is a golfer on a golf course, it may be unreasonable to know with precision whether golfer is playing a hole going in one direction or another while the golfer is looking for his/her stray ball.

Additionally, equipment such as an autonomous mower will not need to sit idle and perhaps waste energy. Rather, the equipment can be dispatched to particular geographic areas to begin tasks at just the right moments when users are leaving the geographic areas.

Likewise, other resources such as water is not wasted by turning irrigation heads on and off while golfers pass through a location that succumbs to heavy evaporation. Rather, the location can be thoroughly watered in one continuous event for effective deep irrigation.

Moreover, such utilization of availability time-windows between golf groups ensures that tasks do not interfere with golf play. Along these lines, there is no waiting by golfers for tasks to end that could negatively impact the golfing experience or cause safety concerns.

While various embodiments of the present disclosure have been particularly shown and described, it will be understood by those skilled in the art that various changes in form and details may be made therein without departing from the spirit and scope of the present disclosure as defined by the appended claims.

For example, certain embodiments described above utilized geofences within which target task locations are situated. In other embodiments, the electronic system 100 monitors current locations of the user devices 104 and simply compares the current locations to target task locations. Such embodiments alleviate the need to use geofences and/or geofencing technology and may instead employ direct location comparisons, etc.

Historically, a golf course superintendent or his assistants would have to coordinate with the golf shop to know what time golfers went off to find gaps in the tee sheet. However, this does not factor in pace or play or current golfer location so the only way to be certain a gap is available was to ride the course to verify there was a gap. Even if a gap became available, it is difficult to determine how much time is available between groups.

Certain techniques disclosed herein are directed to utilizing gaps in golf groups. Along these lines, such techniques may apply to golf course maintenance such as scheduling work tasks on a golf course between golf groups.

It should be appreciated that one of the difficulties golf course superintendents face is attempting to send workers out on the golf course to complete certain tasks while golfers are on the course. To maintain customer/golfer satisfaction, it is important that work does not interfere with golf or interrupt current pace of play. Often times this results in employees sitting at a certain hole and working in intermittent gaps until the task is complete or it is time to clock-out.

In accordance with certain embodiments, specialized circuitry notifies the superintendent of where gaps in play currently are and what tasks can be completed in that gap based on how large the gap is, current pace of play of the nearest group, and the average amount of time a task takes to complete. This allows the superintendent to schedule a task with the confidence in knowing how much work can be accomplished in that time.

In accordance with certain embodiments, the electronic system 100 utilizes a tracking and monitoring subsystem. That is golf fleet tracking capabilities are combined with a golf maintenance activity tracking subsystem to provide an improved task management system. The tracking and monitoring subsystem provides golfer information such as round start time, current pace of play, and current GPS location. The activity tracking subsystem provides target time to complete tasks, such as mowing green or fairways, and provides the average time it takes to complete those tasks. By combining these features, a superintendent can be notified about gaps in play, how much time is available in that gap, and which tasks can be completed based on average time of completion per task. Using this information can provide a recommended list of tasks to the superintendent that have a completion time shorter than the time available in the gap.

The improvements disclosed herein can also be utilized with autonomous mowers to allow the mowers to find the gaps in the progression of devices traveling with golfers through the golf course and mow designated areas without interrupting golf, as well as other equipment (e.g., irrigation systems, etc.). Such a situation provides efficient use of resources and improves the user experience.

It should be understood that the electronic system 100 is appropriate for environments other than golf courses as well. Examples of other environments include airports, factories, transit systems, warehouses, ports, other ground support equipment (GSE) applications, and other similar types of areas where these is trackable movement and gaps or windows that arise in which tasks such as maintenance, resupply, servicing, etc. may be performed. Such modifications and enhancements are intended to belong to various embodiments of the disclosure.

What is claimed is:

1. A method of providing access to a location, the method comprising:
identifying a current device location for a device within a geographic region;
based on the current device location, projecting a time when the device will reach a task target location within the geographic region; and
based on the projected time when the device will reach the task target location within the geographic region, electronically providing an availability time-window to perform a task at the task target location before the device reaches the task target location.

2. The method of claim 1, further comprising:
after the availability time-window is provided, electronically identifying a set of tasks that are performable at the task target location before the device reaches the task target location.

3. The method of claim 2 wherein the geographic region is a golf course;
wherein the task target location is an area on a particular golf course hole of the golf course;
wherein the device is constructed and arranged to travel with a task-ending set of golfers on the golf course; and
wherein electronically identifying the set of tasks that are performable at the task target location includes:
providing a list of groundskeeping tasks that are performable at the area on the particular golf course hole before the task-ending set of golfers reaches the particular golf course hole.

4. The method of claim 3 wherein another device is constructed and arranged to
travel with a task-starting set of golfers on the golf course, the task-starting set of golfers playing ahead of the task-ending set of golfers on the golf course; and
wherein the method further comprises:
projecting a time when the other device will leave the task target location, the availability time-window being a time gap to perform the task at the task target location, the time gap being bounded by the time when the other device will leave the task target location and the time when the device will reach the task target location.

5. The method of claim 4 wherein providing the list of groundskeeping tasks includes:
comparing, to the time gap, a predefined irrigation time to perform an irrigation task that irrigates the area on the particular golf course hole during the predefined irrigation time, and
performing a list update operation, the list update operation adding the irrigation task to the list of groundskeeping tasks when the predefined irrigation time fits within the time gap and omitting the irrigation task from the list of groundskeeping tasks when the predefined irrigation time does not fit within the time gap.

6. The method of claim 4 wherein providing the list of groundskeeping tasks includes:
comparing, to the time gap, a predefined mowing time to perform a mowing task that mows the area on the particular golf course hole during the predefined mowing time, and
performing a list update operation, the list update operation adding the mowing task to the list of groundskeeping tasks when the predefined mowing time fits within the time gap and omitting the mowing task from the list of groundskeeping tasks when the predefined mowing time does not fit within the time gap.

7. The method of claim 3 wherein the golf course includes a sequence of golf course holes;
wherein identifying the current device location for the device within the geographic region includes:
identifying, among the sequence of golf course holes, a current golf course hole within which the device currently resides.

8. The method of claim 7 wherein the device includes global positioning system (GPS) circuitry and a wireless transmitter, the wireless transmitter being constructed and arrange to include a current GPS location identified by the GPS circuitry in the wireless signal; and
wherein identifying the current golf course hole includes:
extracting the current GPS location from the wireless signal, and
mapping the current GPS location to the current golf course hole among the golf course holes of the sequence.

9. The method of claim 7 wherein identifying the current golf course hole includes:
receiving an indication that a Bluetooth detector has detected a Bluetooth beacon;
wherein the Bluetooth detector is one of the device and a Bluetooth apparatus residing at the current golf course hole; and
wherein the Bluetooth beacon is the other of the device and the Bluetooth apparatus residing at the current golf course hole.

10. The method of claim 7 wherein projecting the time when the device will reach the task target location within the geographic region includes:
identifying a series of golf course holes between the current golf course hole and the particular golf course hole of the sequence,
identifying a set of hole playing times for the series of golf course holes between the current golf course hole and the particular golf course hole, and
providing the time when the device will reach the task target location based on an aggregate playing time derived from the set of hole playing times.

11. The method of claim 7 wherein the availability time-window has a start time and an end time; and
wherein electronically providing the availability time-window for performing the task includes:
setting the end time of the availability time-window to be no later than the task-ending timestamp.

12. The method of claim 7 wherein electronically identifying the set of tasks includes:
from a plurality of candidate tasks having predefined task completion times, identifying (i) a set of candidate tasks having predefined task completion times which are shorter than the availability time-window and (ii) a set of candidate tasks having predefined task completion times which are longer the availability time-window,
placing only the set of candidate tasks having predefined task completion times which are shorter than the availability time-window on the list of groundskeeping tasks, the set of candidate tasks having predefined task completion times that are longer than the availability time-window being omitted from the list of groundskeeping tasks.

13. The method of claim 3 wherein projecting the time when the device will reach the task target location within the geographic region includes:
generating, as the time when the device will reach the task target location, an amount of time indicating time remaining before the device reaches the task target location.

14. The method of claim 3 wherein projecting the time when the device will reach the task target location within the geographic region includes:
generating, as the time when the device will reach the task target location, a timestamp indicating a time-of-day at which the device reaches the task target location.

15. Electronic circuitry to provide access to a location, the electronic circuitry comprising:
a set of interfaces; and
a controller coupled with the set of interfaces, the controller being constructed and arranged to perform a method of:
identifying a current device location for a device within a geographic region,
based on the current device location, projecting a time when the device will reach a task target location within the geographic region, and
based on the projected time when the device will reach the task target location within the geographic region, electronically providing an availability time-window to perform a task at the task target location before the device reaches the task target location through the set of interfaces.

16. Electronic circuitry as in claim 15 wherein the method further includes:
after the availability time-window is provided, electronically identifying a set of tasks that are performable at the task target location before the device reaches the task target location.

17. Electronic circuitry as in claim 16 wherein the geographic region is a golf course;
wherein the task target location is an area on a particular golf course hole of the golf course;
wherein the device is constructed and arranged to travel with a task-ending set of golfers on the golf course; and
wherein electronically identifying the set of tasks that are performable at the task target location includes:
providing a list of groundskeeping tasks that are performable at the area on the particular golf course hole before the task-ending set of golfers reaches the particular golf course hole.

18. Electronic circuitry as in claim 17 wherein the golf course includes a sequence of golf course holes;
wherein identifying the current device location for the device within the geographic region includes:
identifying, among the sequence of golf course holes, a current golf course hole within which the device currently resides.

19. Electronic circuitry as in claim 18 wherein another device is constructed and arranged to travel with a task-starting set of golfers on the golf course, the task-starting set of golfers playing ahead of the task-ending set of golfers on the golf course; and
wherein the method further comprises:
projecting a time when the other device will leave the task target location, the availability time-window being a time gap to perform the task at the task target location, the time gap being bounded by the time when the other device will leave the task target location and the time when the device will reach the task target location.

20. A computer program product having a non-transitory computer readable medium which stores a set of instructions to provide access to a location; the set of instructions, when carried out by a processor, causing the processor to perform a method of:
identifying a current device location for a device within a geographic region;
based on the current device location, projecting a time when the device will reach a task target location within the geographic region; and
based on the projected time when the device will reach the task target location within the geographic region, electronically providing an availability time-window to perform a task at the task target location before the device reaches the task target location.
